(19) United States
(12) Patent Application Publication
(10) Pub. No.: US 2018/0220201 A1
(43) Pub. Date: Aug. 2, 2018

(54) AUTOMATIC PERFORMANCE OR CANCELLATION OF SCHEDULED RECORDING

(71) Applicant: OpenTV, Inc., San Francisco, CA (US)

(72) Inventors: Marc Stoksik, Palo Alto, CA (US); Jean-Rene Menand, Los Altos, CA (US); Charles Stevens, Mountain View, CA (US)

(21) Appl. No.: 15/418,842

(22) Filed: Jan. 30, 2017

(51) Int. Cl. H04N 21/84; H04N 21/4147; H04N 21/262; H04N 21/45; H04N 21/258; H04N 21/466; H04N 21/25

(52) U.S. Cl. CPC H04N 21/84; H04N 21/4147; H04N 21/262; H04N 21/4668; H04N 21/25891; H04N 21/4662; H04N 21/251; H04N 21/4532

(57) ABSTRACT

A machine controls a device configured to record media content in accordance with a recording schedule. The machine detects that the device is scheduled to record first media content. The machine accesses a first vector that describes the first media content and in which a first value of a dimension indicates whether a data track exists in the first media content. The machine detects that the device has access to second media content described by a second vector in which a second value of the dimension indicates whether the data track exists in the second media content. The machine may then determine that the first media content is a version of the second media content, based on a comparison of the first and second vectors. The machine may next determine whether the scheduled recording of the first media content is to be performed or canceled by the device.

### TECHNICAL FIELD

The subject matter disclosed herein generally relates to the technical field of special-purpose machines that facilitate control or other management of recording devices, including software-configured computerized variants of such special-purpose machines and improvements to such variants, and to the technologies by which such special-purpose machines become improved compared to other special-purpose machines that facilitate control or other management of recording devices. Specifically, the present disclosure addresses systems and methods to facilitate automatic performance or cancellation of one or more scheduled recordings.

### BACKGROUND

A device (e.g., a smart television, a set-top box, a smartphone, or a personal computer) may be configured to record various media content according to a schedule. For example, the device may have access to an electronic programming guide that indicates a timeslot during which a piece of media content (e.g., audio content, video content, image content, or any suitable combination thereof) will be provided by a media provider (e.g., a media distributor, a media broadcaster, a media multi-caster, or another media source), and the device may be configured (e.g., programmed) by its user to record the media content (e.g., for one or more presentations of the media content at a later time). In many situations, however, the storage capacity of the device may be limited.

### BRIEF DESCRIPTION OF THE DRAWINGS

Some embodiments are illustrated by way of example and not limitation in the figures of the accompanying drawings.

FIG. 1 is a network diagram illustrating a network environment suitable for automatic performance or cancellation of a scheduled recording, according to some example embodiments.

FIG. 2 is a block diagram illustrating components of a controller machine suitable for automatic performance or cancellation of a scheduled recording, according to some example embodiments.

FIG. 3 is a block diagram illustrating components of a device suitable for automatic performance or cancellation of a scheduled recording, according to some example embodiments.

FIG. 4 is a block diagram illustrating information stored by a database, according to some example embodiments.

FIG. 5 is a block diagram illustrating information stored by the device, according to some example embodiments.

FIGS. 6-8 are flowcharts illustrating operations (e.g., of the controller machine) in performing a method of automatically performing or canceling a scheduled recording, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate automatic performance or cancellation of a scheduled recording, and example systems (e.g., special-purpose machines configured by special-purpose software) are configured to facilitate automatic performance or cancellation of a scheduled recording. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A machine (e.g., a server system of one or more server computers) may be configured (e.g., by suitable software) to control a device that has been configured to perform recording (e.g., storage, with or without prior reception) of various media content in accordance with a recording schedule (e.g., a recording schedule that corresponds to the device). According to the systems and methods discussed herein, the machine detects that the recording schedule of the device has scheduled the device to perform storage of first media content to be received. The machine then accesses a first vector (e.g., a first multidimensional vector) that describes the first media content. Furthermore, in the first vector, a first value of a dimension among multiple dimensions indicates whether a data track (e.g., a French subtitle track or a high definition video track) is included in the first media content.

The machine also detects that the device has access to second media content that is described by a second vector (e.g., a second multidimensional vector). In the second vector, a second value of the dimension indicates whether the data track is included in the second media content. Having accessed the first and second vectors, the machine then determines whether the first media content is sufficiently similar to the second media content that the first media content is a version of the second media content. That is, the machine performs a similarity analysis (e.g., a comparison) of the first and second vectors and determines, based on that analysis, whether the first and second media content are different versions of the same media content (e.g., a high-resolution version and a low-resolution version of the same movie).

In some situations, the machine determines that the first media content scheduled for storage by the device is indeed a version of the second media content accessible by the device. As mentioned, this determining may be based on a comparison of the first vector to the second vector. After it has been determined that the first media content is a version of the second media content, the machine determines whether the scheduled storage of the first media content (i.e., an identified version of the second media content) is to be performed or canceled based on the first value that indicates whether the data track is included in the first media content (e.g., and also based on the second value that indicates whether the data track is included in the second media content). Further details are described below.

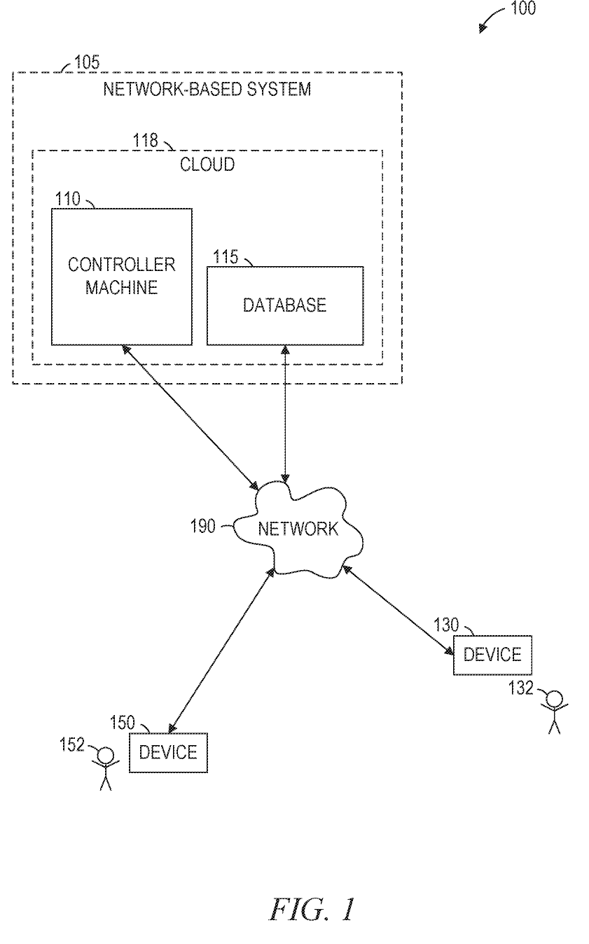

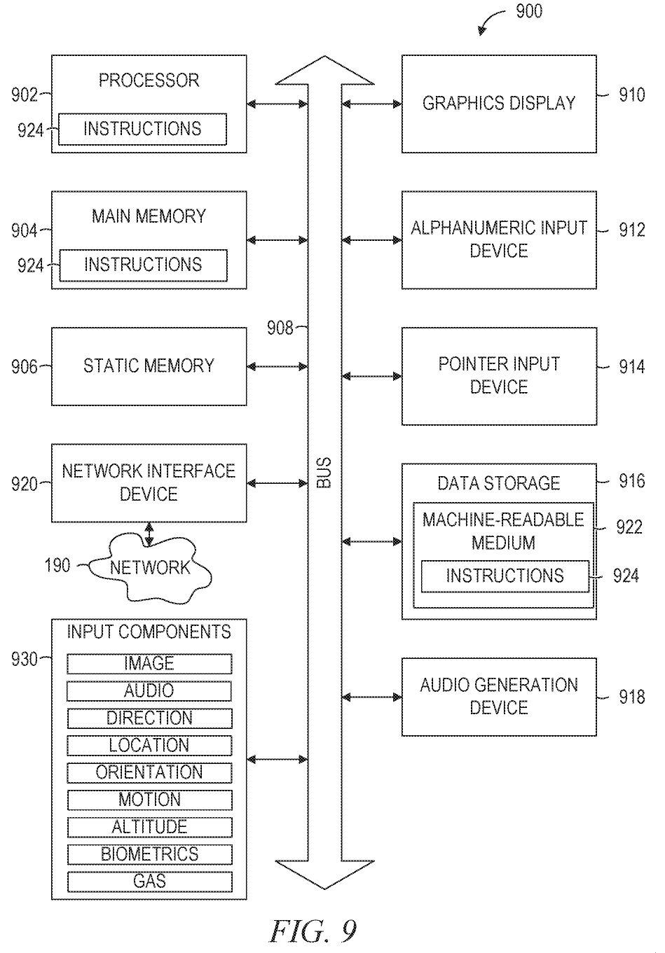

FIG. 1 is a network diagram illustrating a network environment 100 suitable for automatic performance or cancellation of a scheduled recording, according to some example embodiments. The network environment 100 includes a controller machine 110, a database 115, and devices 130 and 150, all communicatively coupled to each other via a network 190. The controller machine 110, with or without the database 115, may form all or part of a cloud 118 (e.g., a geographically distributed set of multiple machines configured to function as a single server), which may form all or part of a network-based system 105 (e.g., a cloud-based server system configured to provide one or more network-based services, such as device control services or other device management services, to the devices 130 and 150). The controller machine 110, the database 115, and the devices 130 and 150 may each be implemented in a special-purpose (e.g., specialized) computer system, in whole or in part, as described below with respect to FIG. 9.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is associated with the device 130 and may be a user of the device 130. For example, the device 130 may be a desktop computer, a vehicle computer, a tablet computer, a navigational device, a portable media device, a set-top box, a smart phone, or a wearable device (e.g., a smart watch, smart glasses, smart clothing, or smart jewelry) belonging to the user 132. Likewise, the user 152 is associated with the device 150 and may be a user of the device 150. As an example, the device 150 may be a desktop computer, a vehicle computer, a tablet computer, a navigational device, a portable media device, a set-top box, a smart phone, or a wearable device (e.g., a smart watch, smart glasses, smart clothing, or smart jewelry) belonging to the user 152.

Any of the systems or machines (e.g., databases and devices) shown in FIG. 1 may be, include, or otherwise be implemented in a special-purpose (e.g., specialized or otherwise non-conventional and non-generic) computer that has been modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 9, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., between the controller machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), a cable television network, a satellite television network, or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

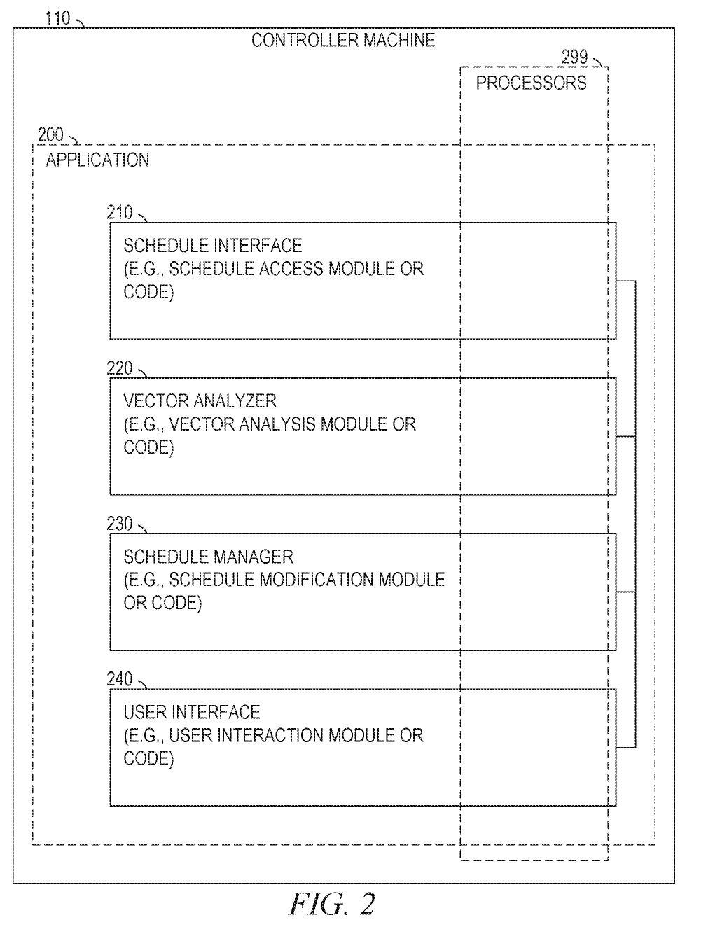

FIG. 2 is a block diagram illustrating components of the controller machine 110, according to some example embodiments. The controller machine 110 is shown as including a schedule interface 210, a vector analyzer 220, a schedule manager 230, and a user interface 240, all configured to communicate with each other (e.g., via a bus, shared memory, or a switch). Accordingly, any one or more of the methodologies described herein may be fully or partially performed by the controller machine 110. According to various example embodiments, the schedule interface 210 may be or include a schedule access module or suitable code; the vector analyzer 220 may be or include a vector analysis module or suitable code; the schedule manager 230 may be or include a schedule modification module or suitable code; and the user interface 240 may be or include a user interaction module or suitable code.

As shown in FIG. 2, the schedule interface 210, the vector analyzer 220, the schedule manager 230, the user interface 240, or any suitable combination thereof may form all or part of an application 200 (e.g., a server-executable application) that is stored (e.g., installed) on the controller machine 110. Furthermore, one or more processors 299 (e.g., hardware processors, digital processors, or any suitable combination thereof) may be included (e.g., temporarily or permanently) in the application 200, the schedule interface 210, the vector analyzer 220, the schedule manager 230, the user interface 240, or any suitable combination thereof.

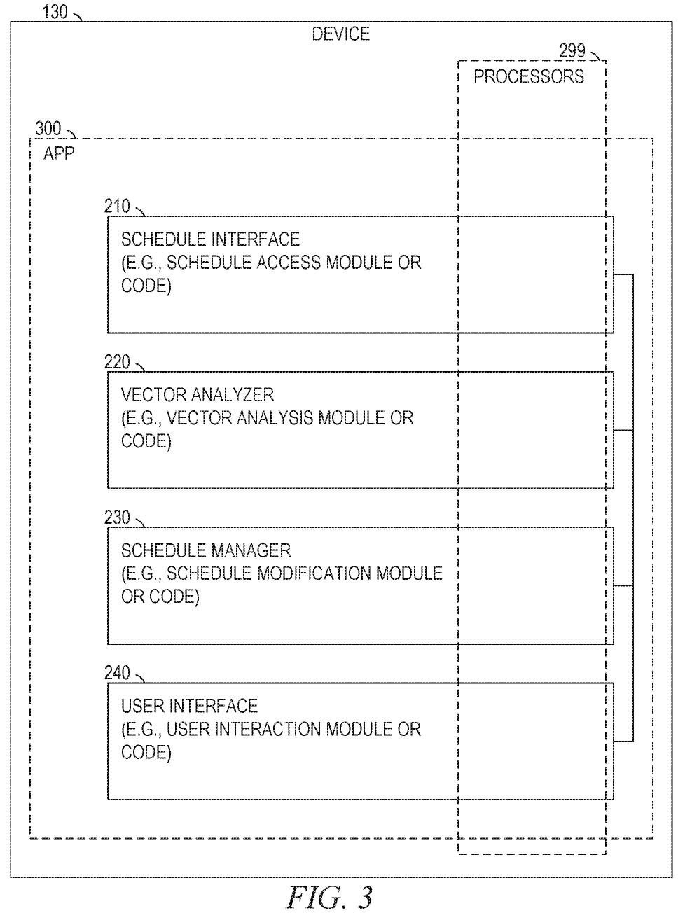

FIG. 3 is a block diagram illustrating components of the device 130, according to some example embodiments. The device 130 is shown as including the schedule interface 210, the vector analyzer 220, the schedule manager 230, and the user interface 240. Accordingly, any one or more of the methodologies described herein may be fully or partially performed by the device 130. As noted above, according to various example embodiments, the schedule interface 210 may be or include a schedule access module or suitable code; the vector analyzer 220 may be or include a vector analysis module or suitable code; the schedule manager 230 may be or include a schedule modification module or suitable code; and the user interface 240 may be or include a user interaction module or suitable code.

As shown in FIG. 3, the schedule interface 210, the vector analyzer 220, the schedule manager 230, the user interface 240, or any suitable combination thereof may form all or part of an app 300 (e.g., a mobile app or other client-executable app) that is stored (e.g., installed) on the device 130. Furthermore, one or more processors 299 (e.g., hardware processors, digital processors, or any suitable combination thereof) may be included (e.g., temporarily or permanently) in the app 300, the schedule interface 210, the vector analyzer 220, the schedule manager 230, the user interface 240, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

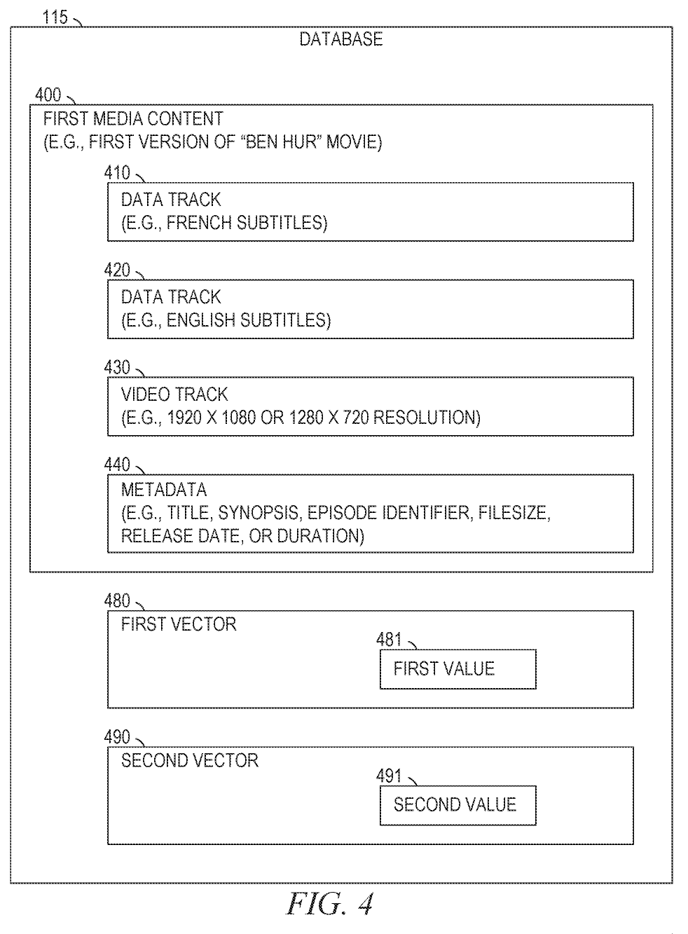

FIG. 4 is a block diagram illustrating information stored by the database 115, according to some example embodiments. As shown, the database 115 stores first media content 400, which may be a first version of a movie or a show (e.g., a version that has a particular subtitle track or a particular video resolution). The database 115 may make the first media content 400 available for recording by one or more devices (e.g., devices 130 and 150) in accordance with a distribution schedule (e.g., a broadcast schedule fully or partially indicated by an electronic programming guide that is accessible to the devices 130 and 150). In some example embodiments, the database 115 is configured to directly provide the first media content 400 to the one or more devices (e.g., via the network 190). In certain example embodiments, the database 115 is configured to provide the first media content 400 to an intermediary server (e.g., the controller machine 110 or another machine within the network-based system 105) that in turn will provide the first media content 400 to the one or more devices (e.g., devices 130 and 150).

As shown in FIG. 4, the first media content 400 can include various information that belongs to, or otherwise corresponds to, the first media content 400 (e.g., one or more data tracks, one or more video tracks, and various metadata). In the example illustrated, the first media content 400 includes data tracks 410 and 420 (e.g., French subtitles and English subtitles, respectively), a video track 430 (e.g., a data track that contains video data), and metadata 440 of the first media content 400. As examples, the data track 410 may be a French subtitle track (e.g., a subtitle track that contains subtitles in the French language); the data track 420 may be an English subtitle track (e.g., a subtitle track that contains subtitles in the English language); the video track 430 may be a high-definition video track (e.g., containing high resolution video at 1280×720 resolution or higher resolution video at 1920×1080 resolution); and the metadata 440 may contain information such as identifiers and descriptors that correspond to the first media content 400 (e.g., title, synopsis, episode identifier, filesize, release date, duration, or any suitable combination thereof). As further examples, the data track 410 may be a first alternate audio track (e.g., director's commentary), and the data track 420 may be second alternate audio track (e.g., actor's commentary).

As shown in FIG. 4, the database 115 may also store one or more multidimensional vectors, such as a first vector 480 that describes the first media content 400. The first vector 480 is a multidimensional descriptive vector in which each dimension among multiple dimensions represents a different attribute of the first media content 400, and each dimension is quantified by a corresponding value that describes the first media content 400 with respect to the corresponding attribute for that dimension. FIG. 4 illustrates a first value 481 of a first dimension among the multiple dimensions of the first vector 480. Additional values of additional dimensions are not shown, but may be present in the first vector 480. According to various example embodiments, the first value 481 may indicate whether the data track 410 (e.g., French subtitles) is included (e.g., present) in the first media content 400 or absent from the first media content 400, whether the data track 420 (e.g., English subtitles) is included in the first media content 400 or absent from the first media content 400, whether a further data track (e.g., Spanish subtitles) is included in the first media content 400 or absent from the first media content 400, whether the video track 430 is present in the first media content 400 or absent from the first media content 400, whether a different video track is present in the first media content 400 or absent from the first media content 400, or whether a portion of the metadata 440 (e.g., title) is present in the first media content 400 or absent from the first media content 400.

Similar multidimensional vectors may be stored in the database 115, and each multidimensional vector may describe different corresponding media content. For example, FIG. 4 additionally illustrates a second vector 490 being stored by the database 115, and the second vector 490 has a second value 491, which may quantify the same dimension quantified by the first value 481, except with respect to media content different from the first media content 400. Additional values of additional dimensions may be present in the second vector 490. Furthermore, according to various example embodiments, the second value 491 may indicate whether the data track 410 (e.g., French subtitles) is included (e.g., present) in or absent from the media content described by the second vector 490, whether the data track 420 (e.g., English subtitles) is included in or absent from the media content described by the second vector 490, whether a further data track (e.g., a Spanish subtitles) is included in or absent from the media content described by the second vector 490, whether the video track 430 is included in or absent from the media content described by the second vector 490, whether a different video track is included in or absent from the media content described by the second vector 490, or whether a portion of the metadata 440 (e.g., title) is included in or absent from the media content described by the second vector 490.

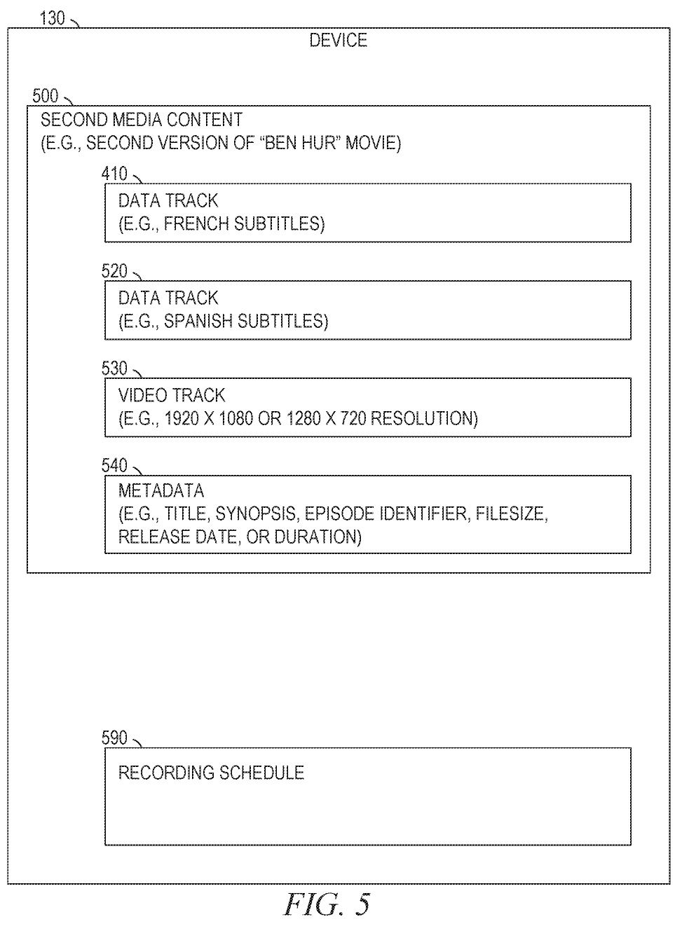

FIG. 5 is a block diagram illustrating information stored by the device 130 (e.g., within one or more internal databases), according to some example embodiments. As shown, the device 130 stores second media content 500, which may be a second version of the same movie or show as the first media content 400. For example, the second media content 500 may be a version that has a subtitle track of a different language than the first media content 400 or has a different video resolution than the first media content 400. In some example embodiments, the device 130 physically stores the second media content 500 and can access the second media content 500 from a local data repository of the device 130 (e.g., an internal drive or internal memory). In certain example embodiments, the device 130 does not store the second media content 500 but can access the second media content 500 via the network 190 (e.g., from the database 115 or from another machine within the network-based system 105).

As shown in FIG. 5, the second media content 500 can include various information that belongs to, or otherwise corresponds to, the second media content 500 (e.g., one or more data tracks, one or more video tracks, and various metadata). In the example illustrated, the second media content 500 includes the data track 410 (e.g., French subtitles, as described above with respect to FIG. 4), a data track 520 (e.g., Spanish subtitles), a video track 530 (e.g., a data track that includes video data), and metadata 540 of the second media content 500. As examples, the data track 410 may be the French subtitle track discussed above with respect to FIG. 4 (e.g., a subtitle track that contains subtitles in the French language); the data track 520 may be a Spanish subtitle track (e.g., a subtitle track that contains subtitles in the Spanish language), the video track 530 may be a high-definition video track (e.g., containing high resolution video at 1280×720 resolution or higher-resolution video at 1920×1080 resolution); and the metadata 540 may contain information such as identifiers and descriptors that correspond to the second media content 500 (e.g., title, synopsis, episode identifier, filesize, release date, duration, or any suitable combination thereof). As further examples, the data track 410 may be a first alternate audio track (e.g., director's commentary), and the data track 520 may be third alternate audio track (e.g., author's commentary).

In view of the above discussion with respect to FIG. 5, the second vector 490 discussed with respect to FIG. 4 may be a multidimensional descriptive vector in which each dimension among multiple dimensions represents a different attribute of the second media content 500, and each dimension is quantified by a corresponding value (e.g., second value 491) that describes the second media content 500 with respect to the corresponding attribute for that dimension. Thus, the second value 491 may quantify the same dimension quantified by the first value 481, except with respect to the second media content 500. Furthermore, according to various example embodiments, the second value 491 may indicate whether the data track 410 (e.g., French subtitles) is included (e.g., present) in the second media content 500 or absent from the second media content 500, whether the data track 420 (e.g., English subtitles) is included in the second media content 500 or absent from the second media content 500, whether the data track 520 (e.g., Spanish subtitles) is included in the second media content 500 or absent from the second media content 500, whether the video track 430 is included in the second media content 500 or absent from the second media content 500, whether the video track 530 is included in the second media content 500 or absent from the second media content 500, whether a portion of the metadata 440 (e.g., title) is included in the second media content 500 or absent from the second media content 500, or whether a portion of the metadata 540 (e.g., synopsis) is included in the second media content 500 or absent from the second media content 500.

As shown in FIG. 5, the device 130 may also store or otherwise have access to a recording schedule 590 according to which the device 130 may be scheduled to perform recording (e.g., storage, with or without prior reception) of various media content (e.g., first media content 400 in the future or second media content 500 in the past). In some example embodiments, the recording schedule 590 is or includes a list of media content (e.g., first media content 400) that has been automatically selected, manually selected (e.g., by the user 132), or any suitable combination thereof, for recording by the device 130. The recording schedule 590 may be generated by the device 130 (e.g., via the schedule manager 230, with a user input received by the user interface 240) based on one or more electronic programming guides (EPGs) that are accessible by the device 130 (e.g., from the database 115 via the network 190). Accordingly, the recording schedule 590 may have scheduled the device 130 to perform a recording of the first media content 400 (e.g., when the first media content 400 is provided to the device 130 by the database 115 or by some other media source within the network-based system 105). In some example embodiments, the recording schedule 590 is not stored by the device 130 but nonetheless accessible by the device 130 via the network 190 (e.g., stored and made available by the database 115, the controller machine 110, or another data source).

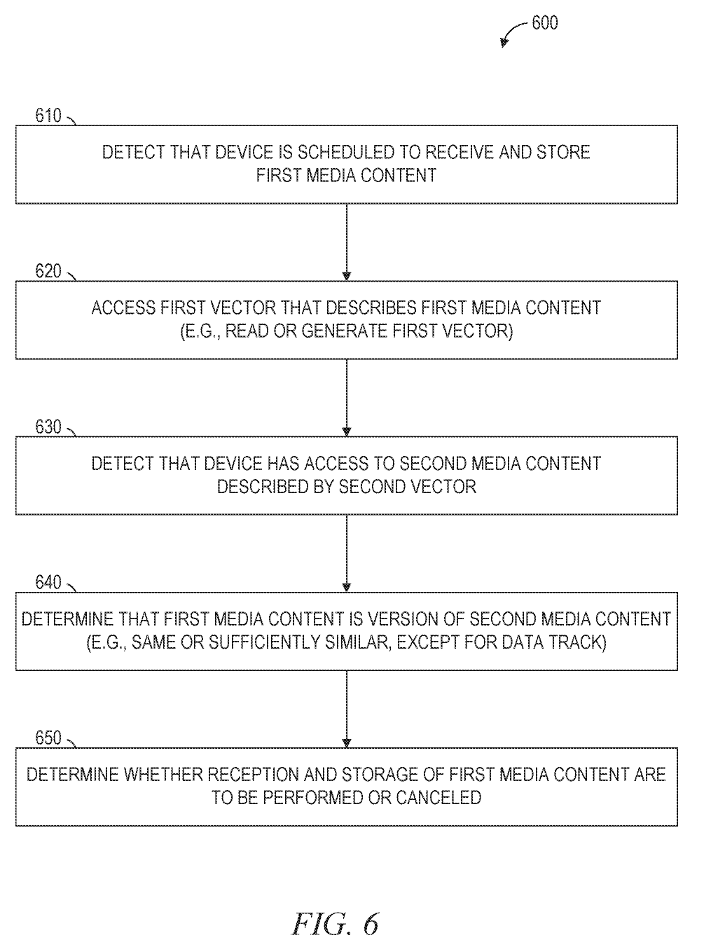

FIGS. 6-8 are flowcharts illustrating operations within a method 600 of automatically performing or canceling a scheduled recording (e.g., storage) of the first media content 400, according to some example embodiments. Operations in the method 600 may be performed by the controller machine 110, the device 130, or any suitable combination thereof, using components (e.g., modules) described above with respect to FIGS. 2 and 3, using one or more processors (e.g., microprocessors or other hardware processors), or using any suitable combination thereof. As shown in FIG. 6, the method 600 includes operations 610, 620, 630, 640, and 650.

In operation 610, the schedule interface 210 detects that the device 130 is scheduled to receive and store the first media content 400. This may be performed by determining, identifying, or otherwise detecting that the recording schedule 590 of the device 130 has scheduled the device 130 to perform such storage of the first media content 400.

In operation 620, the vector analyzer 220 accesses the first vector 480 (e.g., from the database 115). As noted above, the first vector 480 describes the first media content 400 that is scheduled for storage by the device 130, in accordance with the recording schedule 590. In some example embodiments, the accessing of the first vector 480 is performed by reading the first vector 480 from the database 115. In alternative example embodiments, the accessing of the first vector 480 is performed by generating the first vector 480, which may be performed by analyzing one or more tracks (e.g., data track 420 or video track 430) or metadata (e.g., metadata 440) of the first media content 400, creating the first vector 480 based on this analysis, and storing the first vector 480 in the database 115 or the device 130.

As noted above, the first vector 480 may be a multidimensional vector that describes the first media content 400. Furthermore, the first value 481 of the first vector 480 may quantify a dimension among multiple dimensions of the first vector 480, and the first value 481 may indicate whether a data track (e.g., data track 420 or 520, or video track 430 or 530) is included in the first media content 400.

In operation 630, the vector analyzer 220 detects that the device 130 has access to the second media content 500. This may be performed by determining, identifying, or otherwise detecting that the device 130 is capable of retrieving or reading the second media content 500 (e.g., with user permissions corresponding to the user 132). As noted above, the second media content 500 may be described by the second vector 490. For example, in performing operation 630, the vector analyzer 220 may detect that the device 130 is currently storing the second media content 500. In alternative example embodiments, the vector analyzer 220 detects that the device 130 can access the second media content 500 via the network 190 (e.g., from the database 115 or some other data repository in the network-based system 105).

As noted above, the second vector 490 may be a multidimensional vector in which the second value 491 quantifies the same dimension as the first value 481. Thus, the second value 491 may indicate whether the data track (e.g., data track 420 or 520, or video track 430 or 530) discussed above with respect to operation 620 is included in the second media content 500.

In operation 640, the vector analyzer 220 determines whether the first media content 400 is a version of the second media content 500, and the vector analyzer 220 may accordingly determine that the first media content 400 is indeed a version of the second media content 500. That is, the vector analyzer 220 may determine that the first media content 400 and the second media content 500 are two different versions of the same media content (e.g., a high-resolution version and a low-resolution version of the same movie or show, or a French-subtitled version and a Spanish subtitled version of the same movie or show). This may be performed based on a comparison of the first vector 480 to the second vector 490 (e.g., a comparative analysis of dimensional values in the first vector 480 to dimensional values in the second vector 490), and such a comparison may be performed as part of operation 640. Accordingly, performance of operation 640 may result in a determination that, with the exception of a particular track (e.g., data track 420 or 520, or video track 430 or 530) whose presence or absence is indicated by the first value 481 in the first vector 480, the first media content 400 is the same as, or sufficiently similar to (e.g., within a threshold vector distance of), the second media content 500.

In operation 650, the schedule manager 230 determines whether a previously scheduled storage of the first media content 400 (e.g., as specified in the recording schedule 590) is to be performed (e.g., as scheduled) or canceled (e.g., contrary to the recording schedule 590). This determination may be performed based on the first value 481 of the first vector 480, where the first value 481 indicates whether the particular track (e.g., data track 420 or 520 or video track 430 or 530) is included in, or absent from, the first media content 400. One or more additional bases for this determination may apply, according to various example embodiments.

As one example, if the particular track in question is the data track 420 (e.g., English subtitles), the first value 481 may indicate that the data track 420 is present in the first media content 400, while the second value 491 may indicate that the data track 420 is absent from the second media content 500. If there is some indication (e.g., a user preference stored or otherwise accessible by the device 130) that the data track 420 is selected or otherwise desired by the user 132, the scheduled storage of the first media content 400 would be performed (e.g., in accordance with the recording schedule 590). However, if the first value 481 indicates that the data track 420 is absent from the first media content 400, while the second value 491 indicates that the data track 420 is present in the second media content 500, then in view of the indication that the data track 420 is selected or otherwise desired by the user 132, the scheduled storage of the first media content 400 would be canceled (e.g., by modifying the recording schedule 590). Further refinements and factors are discussed below.

As another example, if there is some indication (e.g., a user preference stored or otherwise accessible by the device 130) that a video resolution of 1920×1080 is selected or otherwise desirable by the user 132 (e.g., as well as capable of being displayed by the device 130), the first value 481 may indicate that the video track 430 provides such 1920×1080 video in the first media content 400, while the second value 491 may indicate that the video track 530 does not provide such 1920×1080 video in the second media content 500. That is, the first value 481 may indicate that the desired 1920×1080 video resolution is present in the first media content 400, and the second value 491 may indicate that the desired 1920×1080 video resolution is absent from the second media content 500. As a result of these conditions, in view of the indication that video of 1920×1080 resolution is desired, the scheduled storage of the first media content 400 would be performed (e.g., in accordance with the recording schedule 590). However, if the first value 481 indicates that the video track 430 does not provide such 1920×1080 video resolution in the first media content 400, and if the second value 491 indicates that the video track 530 does provide such 1920×1080 video resolution in the second media content 500, then the scheduled storage of the first media content 400 would be canceled (e.g., by modifying the recording schedule 590). Further refinements and factors are discussed below.

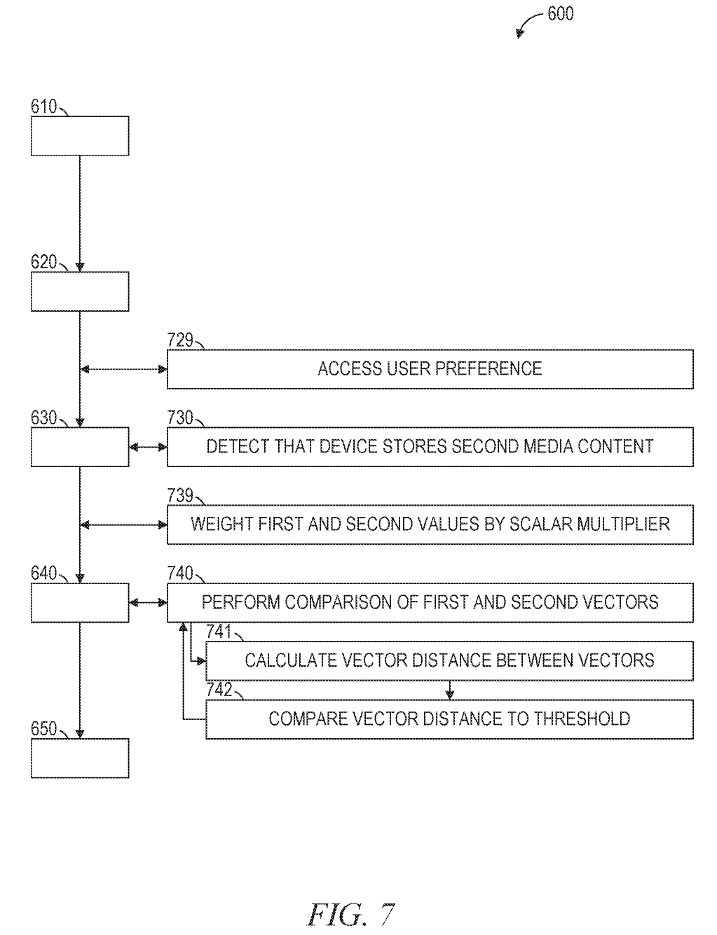

As shown in FIG. 7, in addition to any one or more of the operations previously described, the method 600 may include one or more of operations 729, 730, 739, 740, 741, and 742. In general, operation 729 may be performed at any point prior to operation 650, though in example embodiments in which operation 739 is present, operation 729 may be performed prior to operation 739. In operation 729, the vector analyzer 220 accesses a user preference indicating that the presence or absence of the particular data track (e.g., data track 420 or 520, or video track 430 or 530) is a basis on which to perform operation 650. The user preference may be stored (e.g., as part of a user profile) on the device 130, in the database 115, or both, and accessed therefrom. In example embodiments that include operation 729, the performance of operation 650 may be based on (e.g., performed in response to) the user preference.

Operation 730 may be performed as part (e.g., a precursor task, a subroutine, or a portion) of operation 630, in which the vector analyzer 220 detects that the device 130 has access to the second media content 500. In operation 730, the vector analyzer 220 detects that the device 130 is storing the second media content 500. Accordingly, in some example embodiments that include operation 730, the performance of operation 650 to determine whether storage of the first media content 400 is to be performed or canceled has the effect of determining whether the second media content 500 is to be replaced (e.g., in an effort to optimize or minimize the storage space occupied by media content). In alternative example embodiments that include operation 730, performance of operation 650 has the effect of determining whether the second media content 500 is to be made at least partially redundant by virtue of causing the device 130 to store both the first media content 400 and the second media content 500.

Operation 739 may be performed at any point prior to operation 640, in which the vector analyzer 220 determines that the first media content 400 is a version of the second media content 500. In operation 739, the vector analyzer 220 weights the first value 481 by a scalar multiplier (e.g., a multiplicative coefficient) and weights the second value 491 by the same scalar multiplier. Accordingly, the weighted first value 481 may indicate whether the particular track (e.g., data track 420 or 520, or video track 430 or 530) is included in, or absent from, the first media content 400, and the weighted second value 491 may indicate whether the particular track is included in, or absent from, the second media content 500. In example embodiments that include operation 739, the comparison performed in operation 640 includes comparing the weighted first value 481 to the weighted second value 491.

Furthermore, in example embodiments that include operation 729, the weighting of the first and second values 481 and 491 in operation 739 is performed based on (e.g., in response to) the user preference that was accessed in operation 729. For example, the user preference may specify that presence of the data track 420 (e.g., English subtitles) is a basis for determining whether the scheduled storage of the first media content 400 should be performed or canceled, and operation 739 may accordingly include applying a large scalar multiplier (e.g., a scalar multiplier at or near the maximum among other scalar multipliers supported by the vector analyzer 220) to the first and second values 481 and 491. This may have the effect of amplifying the influence of the first and second values 481 and 491 in operation 640, operation 650, or both.

As shown in FIG. 7, operation 740 may be performed as part of operation 640, in which the vector analyzer 220 determines that the first media content 400 is a version of the second media content 500. In operation 740, the vector analyzer 220 performs a comparison of the first vector 480, which is descriptive of the first media content 400, to the second vector 490, which is descriptive of the second media content 500. This comparison may include a dimension-by-dimension comparison of corresponding values (e.g., first and second values 481 and 491) that quantify each dimension in the first and second vectors 480 and 490.

As additionally shown in FIG. 7, one or both of operations 741 and 742 may be performed as part of operation 740. In operation 741, in performing the comparison of the first and second vectors 480 and 490, the vector analyzer 220 calculates a vector distance between the first and second vectors 480 and 490. In some example embodiments, the vector distance is a Euclidean distance between the first vector 480 and the second vector 490. Furthermore, in example embodiments that include operation 739, the calculation of the vector distance in operation 741 may be based on the weighted first value 481 and the weighted second value 491, as resulting from the weighting of the first and second values 481 and 491 in operation 739.

In operation 742, as part of the comparison of the first and second vectors 480 and 490, the vector analyzer 220 compares the vector distance to a threshold vector distance (e.g., a minimum vector distance or a maximum vector distance). For example, if the calculated vector distance is equal to or less than the threshold vector distance, then in performing operation 640, the vector analyzer 220 may determine that the first and second media content 400 and 500 are sufficiently similar to each other for treatment as two different versions of the same media content.

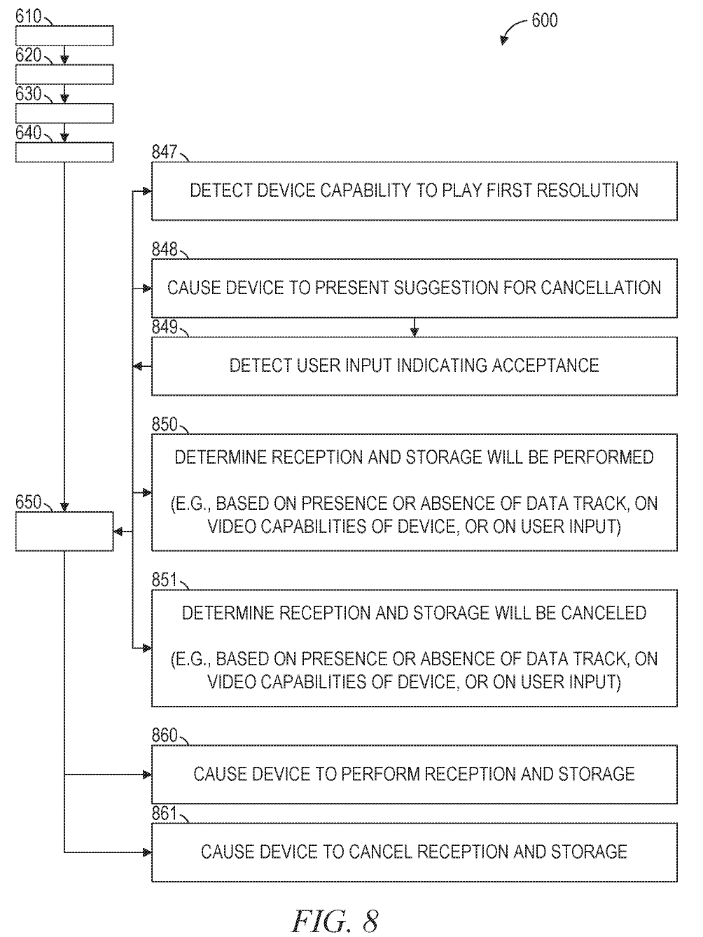

As shown in FIG. 8, in addition to any one or more of the operations previously described, the method 600 may include one or more of operations 847, 848, and 849, may include either operation 850 or operation 851, and may include either operation 860 or operation 861. Furthermore, any one or more of operations 847, 848, 849, 850, and 851 may be performed as part of operation 650, in which the schedule manager 230 determines whether the scheduled recording of the first media item 400 is to be performed or canceled.

According to some example embodiments, the capability of the device 130 to play a particular resolution of video is detected (e.g., queried or otherwise determined) by the schedule manager 230, and the result of this detection is used as a factor in determining in operation 650 whether the scheduled recording of the first media content 400 is to be performed or canceled. Accordingly, in operation 847, the schedule manager 230 detects whether the device 130 is capable of playing video at the resolution (e.g., a first resolution, such as 1920×1080) of the video track 430 in the first media content 400. This may be performed by making an application programming interface (API) call to the device 130 (e.g., to query the operating system or graphics firmware installed thereon).

Thus, in some situations, the schedule manager 230 detects that the device 130 is incapable of playing video at that resolution, and at least partially on that basis, the schedule manager 230 may accordingly determine in operation 650 that the scheduled storage of the first media content 400 are to be canceled (e.g., deleted from the recording schedule 590). Alternatively, in some situations, the schedule manager 230 detects that the device 130 is capable of playing video at that resolution, and at least partially on that basis, the schedule manager 230 may accordingly determine in operation 650 that the scheduled storage of the first media content 400 is to be performed (e.g., preserved in the recording schedule 590).

In operation 848, the user interface 240 causes the device 130 to present (e.g., display) a suggestion that the previously scheduled storage of the first media content 400 be canceled. The presentation of the suggestion may be performed based on (e.g., in response to) a detection in operation 847 that the device 130 does not have the capability to play video at the resolution (e.g., first resolution) of the video track 430 in the first media content 400. The presentation of the suggestion may also be performed based on the absence of a desired track (e.g., data track 520 or video track 530) from the first media content 400 scheduled to be recorded. Although some example embodiments implement automatic cancellation of the scheduled recording of the first media content 400, other example embodiments implement user interactivity by prompting the user 132 to confirm whether the scheduled recording of the first media content 400 should be canceled.

In operation 849, the user interface 240 detects a user input generated by the user 132, and the user input may indicate acceptance of the suggestion presented in operation 848. The detected user input may take the form of a touch, click, or voice command. Accordingly, the user interface 240 in operation 849 detects that the user 132 has approved or otherwise confirmed that the scheduled storage of the first media content 400 are to be canceled, and at least partially on that basis, the schedule manager 230 may accordingly determine in operation 650 that such cancellation is to proceed.

In some example embodiments, operation 850 is performed as part of operation 650, and in such example embodiments, operation 860 is performed after operation 650. In operation 850, the schedule manager 230 determines that the scheduled storage of the first media content 400 is or will be performed (instead of being canceled). This determination may be based on the presence or absence of a track (e.g., data track 420 or 520 or video track 430 or 530) in the first media content 400, on the video display capabilities of the device 130 (e.g., as detected in operation 847) or lack thereof, on user input (e.g., as detected in operation 849) or lack thereof, or on any suitable combination thereof. Accordingly, in operation 860, the schedule manager 230 causes the device 130 to proceed with the previously scheduled receiving and storing of the first media content 400 (e.g., as scheduled by the recording schedule 590). In some example embodiments, the schedule manager 230 takes no action to edit or otherwise modify the recording schedule 590. In alternative example embodiments, the schedule manager 230 sets a flag or other indicator that signifies that the scheduled storage of the first media content 400 is permitted or otherwise enabled to proceed.

In alternative example embodiments, operation 851 is performed as part of operation 650, and in such example embodiments, operation 861 is performed after operation 650. In operation 851, the schedule manager 230 determines that the scheduled storage of the first media content 400 is or will be canceled (instead of being performed). This determination may be based on the presence or absence of a track (e.g., data track 420 or 520 or video track 430 or 530) in the first media content 400, on the video display capabilities of the device 130 (e.g., as detected in operation 847) or lack thereof, on user input (e.g., as detected in operation 849) or lack thereof, or on any suitable combination thereof. Accordingly, in operation 861, the schedule manager 230 causes the device 130 to cancel the previously scheduled receiving and storing of the first media content 400 (e.g., as indicated in the recording schedule 590). In some example embodiments, the schedule manager 230 edits or otherwise modifies the recording schedule 590 (e.g., by deleting or otherwise disabling an instruction to record the first media content 400). In alternative example embodiments, the schedule manager 230 deletes the recording schedule 590 and replaces it with a different recording schedule (e.g., one that omits any instructions to record the first media content 400).

According to various example embodiments, one or more of the methodologies described herein may facilitate automatic performance or cancellation of a scheduled recording of media content. Moreover, one or more of the methodologies described herein may facilitate automatic prevention of recording media content that is redundant with previously stored or otherwise accessible media content. Furthermore, one or more of the methodologies described herein may facilitate automatic prevention of recording media content that cannot be played by the recording device. Still furthermore, one or more of the methodologies described herein may facilitate automatic obtaining of media content with a user-selected or otherwise user-indicated track, such as a particular subtitle track in a particular language or a video track with a particular video resolution. Hence, one or more of the methodologies described herein may facilitate efficient management of data storage resources on a device that records media content, as well as conveniently replacing a previously recorded version of media content with a more user-desired version of the same media content, compared to capabilities of pre-existing systems and methods.

When these effects are considered in aggregate, one or more of the methodologies described herein may obviate a need for certain efforts or resources that otherwise would be involved in such automatic performance or cancellation of a scheduled recording of media content. Efforts expended by a user in managing multiple decisions regarding performance or cancellation of schedule recordings of various media content may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be communicatively coupled (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 904, and a static memory 906, which are configured to communicate with each other via a bus 908. The processor 902 contains solid-state digital microcircuits (e.g., electronic, optical, or both) that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein. In some example embodiments, the processor 902 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 900 with at least the processor 902, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a pointer input device 914 (e.g., a mouse, a touchpad, a touchscreen, a trackball, a joystick, a stylus, a motion sensor, an eye tracking device, a data glove, or other pointing instrument), a data storage 916, an audio generation device 918 (e.g., a sound card, an amplifier, a speaker, a headphone jack, or any suitable combination thereof), and a network interface device 920.

The data storage 916 (e.g., a data storage device) includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the static memory 906, within the processor 902 (e.g., within the processor's cache memory), or any suitable combination thereof, before or during execution thereof by the machine 900. Accordingly, the main memory 904, the static memory 906, and the processor 902 may be considered machine-readable media (e.g., tangible and non-transitory machine-readable media). The instructions 924 may be transmitted or received over the network 190 via the network interface device 920. For example, the network interface device 920 may communicate the instructions 924 using any one or more transfer protocols (e.g., hypertext transfer protocol (HTTP)).

In some example embodiments, the machine 900 may be a portable computing device (e.g., a smart phone, a tablet computer, or a wearable device), and may have one or more additional input components 930 (e.g., sensors or gauges). Examples of such input components 930 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a biometric input component (e.g., a heartrate detector or a blood pressure detector), and a gas detection component (e.g., a gas sensor). Input data gathered by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 924 for execution by the machine 900 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 924).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an API). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media, and systems (e.g., machines, devices, or other apparatus) discussed herein.

A first embodiment provides a method comprising:

detecting, by one or more processors of a machine, that a recording schedule of a device has scheduled the device to perform storage of first media content to be received in the future;
accessing, by one or more processors of the machine, a first multidimensional vector that describes the first media content and indicates (e.g., by including a first value of a dimension among multiple dimensions) whether a data track is included in the first media content;
detecting, by one or more processors of the machine, that the device has access to second media content described by a second multidimensional vector that indicates (e.g., by including a second value of the dimension) whether the data track is included in the second media content;
determining, by one or more processors of the machine, that the first media content scheduled for storage by the device is a version of the second media content accessible by the device, the determining being based on a comparison of the first multidimensional vector to the second multidimensional vector; and
determining, by one or more processors of the machine, whether the scheduled storage of the version of the second media content is to be performed or canceled based on the first value that indicates whether the data track is included in the first media content.

In some example embodiments, the device already stores the second media content. Accordingly, a second embodiment provides a method according to the first embodiment, wherein:

the detecting that the device has access to the second media content includes detecting that the device is storing the second media content.

In certain example embodiments, the first and second values are weighted by a scalar multiplier prior to the comparison of the first and second multidimensional vectors. Accordingly, a third embodiment provides a method according to the first embodiment or the second embodiment, further comprising:

weighting, by a scalar multiplier, the first and second values of the dimension, the weighted first value indicating whether the data track is included in the first media content, the weighted second value indicating whether the data track is included in the second media content; and wherein
the comparison of the first and second multidimensional vectors includes comparing the weighted first value to the weighted second value.

Furthermore, the usage of such weighting may be triggered by or otherwise performed in response to a user preference profile. Accordingly, a fourth embodiment provides a method according to the third embodiment, further comprising:

accessing a user preference that indicates that the data track is a basis on which to perform the determining of whether the scheduled storage of the first media content is to be performed or canceled; and wherein
the weighting of the first and second values by the scalar multiplier is based on the accessed user preference that indicates that the data track is the basis on which to perform the determining of whether the scheduled storage of the first media content is to be performed or canceled.

In some example embodiments, a vector distance is calculated between the first and second multidimensional vectors, and the comparison of the first and second multidimensional vectors is based on this vector distance. Accordingly, fifth embodiment provides a method according to any of the first through fourth embodiments, wherein:

the comparison of the first multidimensional vector to the second multidimensional vector includes calculation of a vector distance between the first and second multidimensional vectors, the vector distance being calculated based on the first value that indicates whether the data track is included in the first media content and based on the second value that indicates whether the data track is included in the second media content.

Moreover, the comparison of the first and second multidimensional vectors may include comparing the calculated vector distance to a threshold vector distance. Accordingly, a sixth embodiment provides a method according to the fifth embodiment, wherein:

the comparison of the first multidimensional vector to the second multidimensional vector includes comparing the calculated vector distance between the first and second multidimensional vectors to a threshold vector distance.

Also, the aforementioned weighting may be performed in conjunction with the calculation of the vector distance. Accordingly, a seventh embodiment provides a method according to the fifth embodiment, further comprising:

weighting, by a scalar multiplier, the first and second values of the dimension; and wherein
the calculation of the vector distance between the first and second multidimensional vectors is based on the weighted first and second values of the dimension.

Furthermore, as mentioned above, such weighting may be triggered by or otherwise performed based on a user preference. Accordingly, an eighth embodiment provides a method according to the seventh embodiment, further comprising:

accessing a user preference that indicates that the data track is a basis on which to perform the determining of whether the scheduled storage of the first media content is to be performed or canceled; and wherein
the weighting of the first and second values by the scalar multiplier is based on the accessed user preference that indicates that the data track is the basis on which to perform the determining of whether the scheduled storage of the first media content is to be performed or canceled.

In some example embodiments, the data track is a subtitle track, and the scheduled recording may be performed (instead of being canceled) based on the subtitle track being present in the first media content but absent from the second media content. Accordingly, a ninth embodiment provides a method according to any of the first through eighth embodiments, wherein:

the data track is a subtitle track that includes subtitles that correspond to the first media content;
the first value in the first multidimensional vector indicates that the subtitle track is included in the first media content scheduled for storage, while the second value in the second multidimensional vector indicates that the subtitle track is absent from the second media content accessible by the device; and
the determining of whether the scheduled storage of the version of the second media content is to be performed or canceled includes determining that the scheduled storage of the version is to be performed based on the subtitle track being included in the first media content but absent from the second media content.

Moreover, the subtitle track may include subtitles in a particular language (e.g., a language of interest to a user, as indicated by a user preference), and performance of the scheduled recording may be based on the particular language of the subtitle track. Accordingly, tenth embodiment provides a method according to the ninth embodiment, wherein:

the subtitle track indicates a language of the subtitles; and
the determining that the scheduled storage of the version is to be performed is based on the language of the subtitles.

In certain example embodiments, the data track is a subtitle track, and the scheduled recording may be canceled (instead of being performed) based on the subtitle track being absent from the first media content but present in the second media content. Accordingly, an eleventh embodiment provides a method according to any of the first through eighth embodiments, wherein:

the data track is a subtitle track that includes subtitles that correspond to the first media content;
the first value in the first multidimensional vector indicates that the subtitle track is absent from the first media content scheduled for storage, while the second value in the second multidimensional vector indicates that the subtitle track is included in the second media content accessible by the device; and
the determining of whether the scheduled storage of the version of the second media content is to be performed or canceled includes determining that the scheduled storage of the version are to be canceled based on the subtitle track being absent from the first media content but included in the second media content.

Moreover, as mentioned above, the subtitle track may include subtitles in a particular language (e.g., a language indicated by a user preference), and cancellation of the recording may be based on the particular language of the subtitle track. Accordingly, a twelfth embodiment provides a method according to the eleventh embodiment, wherein:

the subtitle track indicates a language of the subtitles; and
the determining that the scheduled storage of the version are to be canceled is based on the language of the subtitles.

In some example embodiments, the data track is a high-resolution video track (e.g., 1920×1080 high-definition video or 4K high-definition video), and performance of the scheduled recording may be based on the high-resolution video track being present in the first media content but absent from the second media content, which may have a video track of lower resolution. Accordingly, a thirteenth embodiment provides a method according to any of the first through eighth embodiments, wherein:

the data track is a first video track of the first media content scheduled for storage, the first video track having a first resolution that is larger than a second resolution of a second video track of the second media content accessible by the device; and
the determining of whether the scheduled storage of the version of the second media content is to be performed or canceled includes determining that the scheduled storage of the version is to be performed based on the first resolution of the first video track being larger than the second resolution of the second video track.

On the other hand, in alternative example embodiments, the data track is a high-resolution video track, but cancellation of the scheduled recording may be based on the high-resolution video track being present in the second media content but absent from the first media content, which may have a video track of lower resolution. Accordingly, a fourteenth embodiment provides a method according to any of the first through eighth embodiments, wherein:

the data track is a first video track of the first media content scheduled for storage, the first video track having a first resolution that is smaller than a second resolution of a second video track of the second media content accessible by the device; and
the determining of whether the scheduled storage of the version of the second media content is to be performed or canceled includes determining that the scheduled storage of the version are to be canceled based on the first resolution of the first video track being smaller than the second resolution of the second video track.

In some example embodiments, the video resolution capabilities of the device are explicitly queried or otherwise detected, and the scheduled recording is performed based on a detection that the device is capable of playing video at the resolution of the video track in the first media content. Accordingly, a fifteenth embodiment provides a method according to any of the first through eighth embodiments, wherein:

the data track is a first video track of the first media content scheduled for storage, the first video track having a first resolution that is larger than a second resolution of a second video track of the second media content accessible by the device;
the method further comprises:
detecting that the device is capable of playing video at the first resolution; and wherein
the determining of whether the scheduled storage of the version of the second media content is to be performed or canceled includes determining that the scheduled storage of the version is to be performed based on the device being capable of playing video at the first resolution.

On the other hand, in alternative example embodiments, the video capabilities of the device are detected, but the scheduled recording is canceled based on a detection that the device is incapable of playing video at the resolution of the video track in the first media content. Accordingly, a sixteenth embodiment provides a method according to any of the first through eighth embodiments, wherein:

the data track is a first video track of the first media content scheduled for storage, the first video track having a first resolution that is larger than a second resolution of a second video track of the second media content accessible by the device;
the method further comprises:
detecting that the device is incapable of playing video at the first resolution; and wherein
the determining of whether the scheduled storage of the version of the second media content is to be performed or canceled includes determining that the scheduled storage of the version are to be canceled based on the device being incapable of playing video at the first resolution.

According to certain example embodiments, a machine-prompted interaction with a user includes presentation of a suggestion that the scheduled recording be canceled. Accordingly, a seventeenth embodiment provides a method according to any of the first through sixteenth embodiments, wherein:

the determining of whether the scheduled storage of the version of the second media content is to be performed or canceled includes:
determining that the data track is absent from the first media content but included in the second media content; and
in response to the data track being absent from the first media content but included in the second media content, causing the device to present a suggestion that the scheduled storage of the version be canceled.

In such example embodiments, the machine-prompted interaction with the user may include detecting a user-generated confirmation or other acceptance of the presented suggestion. Accordingly, an eighteenth embodiment provides a method according to the seventeenth embodiment, wherein:

the determining of whether the scheduled storage of the version of the second media content is to be performed or canceled includes:
detecting a user input that indicates acceptance of the presented suggestion that the scheduled storage of the version be canceled; and
in response to the user input, causing the device to cancel the scheduled storage of the version.

A nineteenth embodiment provides a machine-readable medium (e.g., a non-transitory machine-readable storage medium) comprising instructions that, when executed by one or more processors of a machine, cause the machine to perform operations comprising:

detecting that a recording schedule of a device has scheduled the device to perform storage of first media content to be received in the future;
accessing a first multidimensional vector that describes the first media content and indicates (e.g., by including a first value of a dimension among multiple dimensions) whether a data track is included in the first media content;
detecting that the device has access to second media content described by a second multidimensional vector that indicates (e.g., by including a second value of the dimension) whether the data track is included in the second media content;
determining that the first media content scheduled for storage by the device is a version of the second media content accessible by the device, the determining being based on a comparison of the first multidimensional vector to the second multidimensional vector; and
determining whether the scheduled storage of the version of the second media content is to be performed or canceled based on the first value that indicates whether the data track is included in the first media content.

A twentieth embodiment provides a system (e.g., a server computer system) comprising:

one or more processors; and
a memory storing instructions that, when executed by at least one processor among the one or more processors, cause the system to perform operations comprising:
detecting that a recording schedule of a device has scheduled the device to perform storage of first media content to be received in the future;
accessing a first multidimensional vector that describes the first media content and indicates (e.g., by including a first value of a dimension among multiple dimensions) whether a data track is included in the first media content;
detecting that the device has access to second media content described by a second multidimensional vector that indicates (e.g., by including a second value of the dimension) whether the data track is included in the second media content;
determining that the first media content scheduled for storage by the device is a version of the second media content accessible by the device, the determining being based on a comparison of the first multidimensional vector to the second multidimensional vector; and
determining whether the scheduled storage of the version of the second media content is to be performed or canceled based on the first value that indicates whether the data track is included in the first media content.

A twenty-first embodiment provides a carrier medium carrying machine-readable instructions for controlling a machine to carry out the method of any one of the first through eighteenth embodiments.

What is claimed is:

1. A method comprising:
detecting, by one or more processors of a machine, that a recording schedule of a device has scheduled the device to perform storage of first media content to be received;
accessing, by one or more processors of the machine, a first multidimensional vector that describes the first media content and indicates whether a data track is included in the first media content;
detecting, by one or more processors of the machine, that the device has access to second media content described by a second multidimensional vector that indicates whether the data track is included in the second media content;
determining, by one or more processors of the machine, that the first media content scheduled for storage by the device is a version of the second media content accessible by the device, the determining being based on a comparison of the first multidimensional vector to the second multidimensional vector; and
determining, by one or more processors of the machine, whether the scheduled storage of the version of the second media content is to be performed or canceled based on the first value that indicates whether the data track is included in the first media content.

2. The method of claim 1, wherein:
the detecting that the device has access to the second media content includes detecting that the device is storing the second media content.

3. The method of claim 1, further comprising:
weighting, by a scalar multiplier, the first and second values of the dimension, the weighted first value indicating whether the data track is included in the first media content, the weighted second value indicating whether the data track is included in the second media content; and wherein
the comparison of the first and second multidimensional vectors includes comparing the weighted first value to the weighted second value.

4. The method of claim 3, further comprising:
accessing a user preference that indicates that the data track is a basis on which to perform the determining of whether the scheduled storage of the first media content is to be performed or canceled; and wherein
the weighting of the first and second values by the scalar multiplier is based on the accessed user preference that indicates that the data track is the basis on which to perform the determining of whether the scheduled storage of the first media content is to be performed or canceled.

5. The method of claim 1, wherein:
the comparison of the first multidimensional vector to the second multidimensional vector includes calculation of a vector distance between the first and second multidimensional vectors, the vector distance being calculated based on the first value that indicates whether the data track is included in the first media content and based on the second value that indicates whether the data track is included in the second media content.

6. The method of claim 5, wherein:
the comparison of the first multidimensional vector to the second multidimensional vector includes comparing the calculated vector distance between the first and second multidimensional vectors to a threshold vector distance.

7. The method of claim 5, further comprising:
weighting, by a scalar multiplier, the first and second values of the dimension; and wherein
the calculation of the vector distance between the first and second multidimensional vectors is based on the weighted first and second values of the dimension.

8. The method of claim 7, further comprising:
accessing a user preference that indicates that the data track is a basis on which to perform the determining of whether the scheduled storage of the first media content is to be performed or canceled; and wherein
the weighting of the first and second values by the scalar multiplier is based on the accessed user preference that indicates that the data track is the basis on which to perform the determining of whether the scheduled storage of the first media content is to be performed or canceled.

9. The method of claim 1, wherein:
the data track is a subtitle track that includes subtitles that correspond to the first media content;
the first value in the first multidimensional vector indicates that the subtitle track is included in the first media content scheduled for storage, while the second value in the second multidimensional vector indicates that the subtitle track is absent from the second media content accessible by the device; and
the determining of whether the scheduled storage of the version of the second media content is to be performed or canceled includes determining that the scheduled storage of the version is to be performed based on the subtitle track being included in the first media content but absent from the second media content.

10. The method of claim 9, wherein:
the subtitle track indicates a language of the subtitles; and
the determining that the scheduled storage of the version is to be performed is based on the language of the subtitles.

11. The method of claim 1, wherein:
the data track is a subtitle track that includes subtitles that correspond to the first media content;
the first value in the first multidimensional vector indicates that the subtitle track is absent from the first media content scheduled for storage, while the second value in the second multidimensional vector indicates that the subtitle track is included in the second media content accessible by the device; and
the determining of whether the scheduled storage of the version of the second media content is to be performed or canceled includes determining that the scheduled storage of the version are to be canceled based on the subtitle track being absent from the first media content but included in the second media content.

12. The method of claim 11, wherein:
the subtitle track indicates a language of the subtitles; and
the determining that the scheduled storage of the version are to be canceled is based on the language of the subtitles.

13. The method of claim 1, wherein:
the data track is a first video track of the first media content scheduled for storage, the first video track having a first resolution that is larger than a second resolution of a second video track of the second media content accessible by the device; and
the determining of whether the scheduled storage of the version of the second media content is to be performed or canceled includes determining that the scheduled storage of the version is to be performed based on the first resolution of the first video track being larger than the second resolution of the second video track.

14. The method of claim 1, wherein:
the data track is a first video track of the first media content scheduled for storage, the first video track having a first resolution that is smaller than a second resolution of a second video track of the second media content accessible by the device; and
the determining of whether the scheduled storage of the version of the second media content is to be performed or canceled includes determining that the scheduled storage of the version are to be canceled based on the first resolution of the first video track being smaller than the second resolution of the second video track.

15. The method of claim 1, wherein:
the data track is a first video track of the first media content scheduled for storage, the first video track having a first resolution that is larger than a second resolution of a second video track of the second media content accessible by the device;
the method further comprises:
detecting that the device is capable of playing video at the first resolution; and wherein
the determining of whether the scheduled storage of the version of the second media content is to be performed or canceled includes determining that the scheduled storage of the version is to be performed based on the device being capable of playing video at the first resolution.

16. The method of claim 1, wherein:
the data track is a first video track of the first media content scheduled for storage, the first video track having a first resolution that is larger than a second resolution of a second video track of the second media content accessible by the device;
the method further comprises:
detecting that the device is incapable of playing video at the first resolution; and wherein
the determining of whether the scheduled storage of the version of the second media content is to be performed or canceled includes determining that the scheduled storage of the version are to be canceled based on the device being incapable of playing video at the first resolution.

17. The method of claim 1, wherein:
the determining of whether the scheduled storage of the version of the second media content is to be performed or canceled includes:
determining that the data track is absent from the first media content but included in the second media content; and
in response to the data track being absent from the first media content but included in the second media content, causing the device to present a suggestion that the scheduled storage of the version be canceled.

18. The method of claim 17, wherein:
the determining of whether the scheduled storage of the version of the second media content is to be performed or canceled includes:
detecting a user input that indicates acceptance of the presented suggestion that the scheduled storage of the version be canceled; and
in response to the user input, causing the device to cancel the scheduled storage of the version.

19. A non-transitory machine-readable storage medium comprising instructions that, when executed by one or more processors of a machine, cause the machine to perform operations comprising:
detecting that a recording schedule of a device has scheduled the device to perform storage of first media content to be received;
accessing a first multidimensional vector that describes the first media content and in which a first value of a dimension among multiple dimensions indicates whether a data track is included in the first media content;
detecting that the device has access to second media content described by a second multidimensional vector in which a second value of the dimension indicates whether the data track is included in the second media content;
determining that the first media content scheduled for storage by the device is a version of the second media content accessible by the device, the determining being based on a comparison of the first multidimensional vector to the second multidimensional vector; and
determining whether the scheduled storage of the version of the second media content is to be performed or canceled based on the first value that indicates whether the data track is included in the first media content.

20. A system comprising:
one or more processors; and
a memory storing instructions that, when executed by at least one processor among the one or more processors, cause the system to perform operations comprising:
detecting that a recording schedule of a device has scheduled the device to perform storage of first media content to be received;
accessing a first multidimensional vector that describes the first media content and in which a first value of a dimension among multiple dimensions indicates whether a data track is included in the first media content;
detecting that the device has access to second media content described by a second multidimensional vector in which a second value of the dimension indicates whether the data track is included in the second media content;
determining that the first media content scheduled for storage by the device is a version of the second media content accessible by the device, the determining being based on a comparison of the first multidimensional vector to the second multidimensional vector; and
determining whether the scheduled storage of the version of the second media content is to be performed or canceled based on the first value that indicates whether the data track is included in the first media content.
